(19) United States
(12) Patent Application Publication
(10) Pub. No.: US 2024/0273490 A1
(43) Pub. Date: Aug. 15, 2024

(54) TECHNOLOGY FOR AGGREGATED ACCOUNT DISPLAY OF HOST FINANCIAL ACCOUNTS AND EXTERNAL THIRD-PARTY FINANCIAL ACCOUNTS IN A SECURE AUTHENTICATED NETWORK ENVIRONMENT

(71) Applicant: Truist Bank, Charlotte, NC (US)

(72) Inventors: Kristen Martin, Charlotte, NC (US); Candace Roberts, Charlotte, NC (US); Erin Nash, Charlotte, NC (US); Jennifer Herring, Charlotte, NC (US)

(21) Appl. No.: 18/168,072

(22) Filed: Feb. 13, 2023

(51) Int. Cl. G06Q 20/10; G06Q 20/02

(52) U.S. Cl. CPC G06Q 20/108; G06Q 20/02

(57) ABSTRACT

An apparatus, computing device, computer program product, and a computer-implemented method for aggregating a plurality of financial accounts for display on a user interface of a client device, and facilitating financial transactions (e.g., fund transfers) between financial accounts maintained by a host financial institution and financial accounts maintained by third-party financial institutions while executing a mobile application associated with the host financial institution.

### TECHNICAL FIELD

The present disclosure relates to an apparatus, a computing device, a computer program product, and a computer-implemented method for delivering enhanced digital financial services, and more particularly, for aggregating a plurality of financial accounts for visual display on a user interface of a client device, and facilitating financial transactions (e.g., fund transfers, bill payment) between financial accounts maintained by a host financial institution and financial accounts maintained by third-party financial institutions.

### BACKGROUND

Currently there exists software applications associated with a financial institution (running on a web site or an ‘app’ running on a portable computing device) which can visually display data/information (e.g., account balances, transactions, etc.) associated about a financial account maintained by the financial institution, and also visually display balances and transactions from accounts at maintained by third-party financial institutions. A computing device can auto-login to different financial accounts at different financial institutions to obtain data/information associated with account balances and transactions. The web site (or app) can then display all of the balances (and transactions, etc.) on a single display even though the accounts are at different financial institutions.

Bill pay digital platforms are used to pay payees using a software application associated with a financial institution. Payees and data/information associated therewith (e.g., corporate address) and payments can be made using the software application by identifying a particular payee and indicating the monetary amount. The software application can then automatically pay the payee the specified monetary amount (e.g., by mailing a check, etc.).

### SUMMARY

The present disclosure relates to an apparatus, a computer program product, and a computer-implemented method for delivering enhanced digital financial services over a communication network by providing a digital financial management platform for a client device. In particular, a user having one or more financial accounts maintained at a host financial institution, can conduct financial transactions (e.g., fund transfers) between financial accounts maintained by the host financial institution and also financial accounts maintained by third-party financial institutions while executing a mobile software application associated with the host financial institution or an online software application associated with the host financial institution.

In accordance with one or more embodiments set forth, illustrated and described herein, an apparatus comprises one or more of the following: one or more processors and a non-transitory memory coupled to the one or more processors, the non-transitory memory including a set of instructions of computer-executable program code, which when executed by the one or more processors, cause the apparatus to cause a user device executing a mobile software application associated with a host financial institution to display on the user device a balance of a first account held at a first financial institution and a balance of a second account held at a second financial institution, the first financial institution being different from the second financial institution, receive a request from the user device executing the mobile application software or desktop application software to transfer an amount of funds from the first account to the second account, and initiate, in response to the request from the user device, a transfer of funds at a first financial institution server associated with the first financial institution of the amount of funds from the first account at the first financial institution into the second account at the second financial institution.

In accordance with the apparatus, the apparatus enables the first financial institution to be the host financial institution.

In accordance with the apparatus, the apparatus enables the second financial institution to be the host financial institution.

In accordance with the apparatus, the apparatus enables both the first financial institution and the second financial institution to not be the host financial institution.

In accordance with the apparatus, the set of instructions, which when executed by the one or more processors, causes the apparatus to verify the first account has at least the amount of funds before implementing the transfer.

In accordance with the apparatus, the set of instructions, which when executed by the one or more processors, causes the apparatus to store a list of third-party financial institution servers and their respective login credentials.

In accordance with the apparatus, the set of instructions, which when executed by the one or more processors, causes the apparatus to transfer the funds immediately to the second account when the second account is held at the host financial institution.

In accordance with one or more embodiments illustrated, set forth, and described herein, a computer-implemented method comprises one or more of the following: causing, by one or more host financial institution servers associated with a host financial institution, a user device executing a mobile application associated with the host financial institution, to display a balance of a first account held at a first financial institution and a balance of a second account held at a second financial institution, the first financial institution being different from the second financial institution; receiving, by the one or more host financial institution servers, a request from the user device executing the mobile application software or desktop application software to transfer an amount of funds from the first account to the second account; and initiating, by the one or more host financial institution servers, in response to the receiving the request from the user device, a transfer of funds at a first financial institution server(s) associated with the first financial institution of the amount of funds from the first account at the first financial institution into the second account at the second financial institution.

In accordance with the computer-implemented method, further comprising enabling the first financial institution to be the host financial institution.

In accordance with the computer-implemented method, further comprising enabling the second financial institution to be the host financial institution.

In accordance with the computer-implemented method, further comprising enabling the first financial institution and the second financial institution to both be not the host financial institution.

In accordance with the computer-implemented method, further comprising, verifying, by the one or more host financial institution servers, that the first account has at least the amount of funds before implementing the transfer.

In accordance with the computer-implemented method, further comprising storing, by the one or more host financial institution servers, a list of third-party financial institution servers and their respective login credentials.

In accordance with the computer-implemented method, further comprising causing, by the one or more host financial institution servers, the funds to be immediately received by the second account when the second account is held by the host financial institution.

In accordance with one or more embodiments set forth, illustrated and described herein, a computer program product comprising at least one non-transitory computer readable medium having with a set of instructions of computer-executable program code, which when executed by one or more processors of a computing device, cause the computing device cause a user device executing a mobile application associated with a host financial institution to display on the user device a balance of a first account held at a first financial institution and a balance of a second account held at a second financial institution, the first financial institution being different from the second financial institution; receive a request from the user device executing the mobile application to transfer an amount of funds from the first account to the second account; and initiate, in response to the request from the user device, a transfer of funds at a first financial institution server associated with the first financial institution of the amount of funds from the first account at the first financial institution into the second account at the second financial institution.

In accordance with the computer program product, the set of instructions, which when executed by the one or more processors, causes the computing device to enable the first financial institution to be the host financial institution.

In accordance with the computer program product, the set of instructions, which when executed by the one or more processors, causes the computing device to enable the second financial institution to be the host financial institution.

In accordance with the computer program product, the set of instructions, which when executed by the one or more processors, causes the computing device to enable the first financial institution and the second financial institution to not be the host financial institution.

In accordance with the computer program product, the set of instructions, which when executed by the one or more processors, causes the computing device to verify the first account has at least the amount of funds before the transfer is implemented.

In accordance with the computer program products, the set of instructions, which when executed by the one or more processors, causes the computing device to store a list of third-party financial institution servers and their respective login credentials.

In accordance with one or more embodiments set forth, illustrated and described herein, an apparatus comprises one or more of the following: one or more processors; and a non-transitory memory coupled to the one or more processors, the non-transitory memory including a set of instructions of computer-executable program code, which when executed by the one or more processors, cause the apparatus to: cause, during execution of mobile application software or desktop application software associated with a host financial institution by a client device of a user having one or more financial accounts maintained by the host financial institution, a rendering of a graphical user interface (GUI) for visual display on a user interface of the client device, the GUI enabling the user to preview account balances of the one or more financial accounts maintained by the host financial institution and one or more financial accounts maintained by a third-party financial institution; receive, from the client device, a user request to engage in an inter-account funds transfer between a source account and a destination account taken from the host financial institution and one of the third-party financial institutions; and initiate, in response to the user request, the inter-account funds transfer.

In accordance with the apparatus, the GUI comprises a dashboard that includes one or more widgets that correspond to the third-party financial institutions,

In accordance with the apparatus, the one or more widgets are user-engageable to enable user-manipulation in order to customize the visual display of the GUI.

In accordance with the apparatus, a source account of the funds transfer is the one or more financial accounts maintained by the host financial institution, and a destination account of the funds transfer is the one or more financial accounts maintained by the third-party financial institutions.

In accordance with the apparatus, the source account of the funds transfer is the one or more financial accounts maintained by the third-party financial institutions, and the destination account of the funds transfer is the one or more financial accounts maintained by the host financial institution.

In accordance with the apparatus, the set of instructions, which when executed by the one or more processors, causes the apparatus to verify, temporally before causing the funds transfer, that the source account has at least an amount of funds.

In accordance with the apparatus, the set of instructions, which when executed by the one or more processors, causes the apparatus to execute a calculation of a financial net worth of the user based on the previewed account balances of the one or more financial accounts maintained by the host financial institution and the account balances of the financial accounts maintained by one or more third-party financial institutions.

In accordance with the apparatus, the set of instructions, which when executed by the one or more processors, causes the apparatus to cause a visual display of the calculated financial net worth on the user interface of the client device.

In accordance with one or more embodiments set forth, illustrated and described herein, a computer-implemented method comprises one or more of the following: causing, by one or more host financial institution servers associated with a host financial institution during execution of mobile application software or desktop application software associated with the host financial institution by a client device of a user having one or more financial accounts maintained by the host financial institution, a rendering of a GUI for visual display on a user interface of the client device, the GUI enabling the user to preview account balances of the one or more financial accounts maintained by the host financial institution and one or more financial accounts maintained by a third-party financial institution; receiving, by the one or more host financial institution servers from the client device, a user request to engage in an inter-account funds transfer between a source account and a destination account taken from the host financial institution and one of the third-party financial institutions; and initiate, by the one or more host financial institution servers in response to the user request, the inter-account funds transfer.

In accordance with the computer-implemented method, the GUI comprises a dashboard that includes one or more widgets that correspond to the third-party financial institutions.

In accordance with the computer-implemented method, the one or more widgets are user-engageable to enable user-manipulation in order to customize the visual display of the GUI.

In accordance with the computer-implemented method, a source account of the funds transfer is the one or more financial accounts maintained by the host financial institution, and a destination account of the funds transfer is the one or more financial accounts maintained by the third-party financial institutions.

In accordance with the computer-implemented method, a source account of the funds transfer is the one or more financial accounts maintained by the third-party financial institutions, and a destination account of the funds transfer is the one or more financial accounts maintained by the host financial institution.

In accordance with the computer-implemented method, further comprising verifying, by the one or more host financial institution servers temporally before causing the funds transfer, that the source account has at least an amount of funds.

In accordance with the computer-implemented method, further comprising verifying, by the one or more host financial institution servers temporally before causing the funds transfer, that the source account has at least an amount of funds.

In accordance with the computer-implemented method, further comprising executing, by the one or more host financial institution servers, a calculation of a financial net worth of the user based on the previewed account balances of the one or more financial accounts maintained by the host financial institution and the account balances of the financial accounts maintained by one or more third-party financial institutions.

In accordance with the computer-implemented method, further comprising causing a visual display, by the one or more host financial institution servers, of the calculated financial net worth on the user interface of the client device.

In accordance with one or more embodiments set forth, illustrated and described herein, a computer program product comprising at least one non-transitory computer readable medium having with a set of instructions of computer-executable program code, which when executed by one or more processors of a computing device, causes the computing device to perform one or more of the following: cause, during execution of mobile application software or desktop application software associated with a host financial institution by a client device of a user having one or more financial accounts maintained by the host financial institution, a rendering of a GUI for visual display on a user interface of the client device, the GUI enabling the user to preview account balances of the one or more financial accounts maintained by the host financial institution and one or more financial accounts maintained by a third-party financial institution; receive, from the client device, a user request to engage in an inter-account funds transfer between a source account and a destination account taken from the host financial institution and one of the third-party financial institutions; and initiate, in response to the user request, the inter-account funds transfer.

In accordance with the computer program product, the source account of the funds transfer is the one or more financial accounts maintained by the host financial institution, and the destination account of the funds transfer is the one or more financial accounts maintained by the third-party financial institutions.

In accordance with the computer program product, the source account of the funds transfer is the one or more financial accounts maintained by the third-party financial institutions, and the destination account of the funds transfer is the one or more financial accounts maintained by the host financial institution.

In accordance with the computer program product, the set of instructions, which when executed by the one or more processors, causes the computing device to verify, temporally before causing the funds transfer, that the source account has at least an amount of funds.

In accordance with the computer program product, the set of instructions, which when executed by the one or more processors, causes the computing device to verify, temporally before causing the funds transfer, that the source account has at least an amount of funds.

In accordance with the computer program product, the set of instructions, which when executed by the one or more processors, causes the computing device to execute a calculation of a financial net worth of the user based on the previewed account balances of the one or more financial accounts maintained by the host financial institution and the account balances of the financial accounts maintained by one or more third-party financial institutions.

In accordance with the computer program product, the set of instructions, which when executed by the one or more processors, causes the computing device to cause a visual display of the calculated financial net worth on the user interface of the client device.

### DRAWINGS

The various advantages of the exemplary embodiments will become apparent to one skilled in the art by reading the following specification and appended claims, and by referencing the following drawings, in which:

FIG. 1 illustrates a communication environment in accordance with one or more embodiments set forth and described herein.

FIG. 2 illustrates a block diagram of the mobile device of FIG. 1, in accordance with one or more embodiments set forth and described herein.

FIG. 3 illustrates a block diagram of the personal computing device of FIG. 1, in accordance with one or more embodiments set forth and described herein.

FIG. 4 illustrates a block diagram of the one or more financial institution servers of FIG. 1, in accordance with one or more embodiments set forth and described herein.

FIG. 5 illustrates a user interface of the client device of FIG. 1, in accordance with one or more embodiments set forth and described herein.

FIGS. 6 through 10 respectively illustrate a GUI for visual display on the user interface of FIG. 5, in accordance with one or more embodiments set forth and described herein.

FIGS. 11 through 15 respectively illustrate exemplary computer-implemented methods, in accordance with one or more embodiments set forth and described herein.

FIG. 16 illustrates a GUI interface for capturing data/information associated with payees from a third-party bill pay digital platform into a host bill pay digital platform, in accordance with one or more embodiments as set forth and described herein.

### DESCRIPTION

Herein below are example definitions that are provided only for illustrative purposes in this disclosure, and should not be construed to limit the scope of the one or more embodiments disclosed herein in any manner. Some terms are defined below for purposes of clarity. These terms are not rigidly restricted to these definitions. This disclosure contemplates that these terms and other terms may also be defined by their use in the context of this description.

As used herein, “application” relates to software used on a computer (usually by a client and/or client device and can be applications that are targeted or supported by specific classes of machine, such as a mobile application, desktop application, tablet application, and/or enterprise application (e.g., client device application(s) on a client device). Applications may be separated into applications which reside on a client device (e.g., VPN, PowerPoint, Excel) and cloud applications which may reside in the cloud (e.g., Gmail, GitHub). Cloud applications may correspond to applications on the client device or may be other types such as social media applications (e.g., Facebook).

As used herein, “artificial intelligence (AI)” relates to one or more computer system operable to perform one or more tasks that normally require human intelligence, such as visual perception, speech recognition, decision-making, and translation between languages.

As used herein, “dynamically” relates to events or actions that can be caused, triggered, or otherwise occur without human intervention.

As used herein, “machine learning” relates to an application of Al that provides computer systems the ability to automatically learn and improve from data and experience without being explicitly programmed.

As used herein, “computer” relates to a single computer or to a system of interacting computers. A computer is a combination of a hardware system, a software operating system and perhaps one or more software application programs. Examples of a computer include without limitation a personal computer (PC), laptop computer, a smart phone, a cell phone, or a wireless tablet.

As used herein, “client device” relates to any device associated with a user, including personal computers, laptops, tablets, and/or mobile smartphones.

As used herein, “modules” relates to either software modules (e.g., code embodied on a machine-readable medium or in a transmission signal) or hardware modules. Certain embodiments are described herein as including logic or a number of components, modules, or mechanisms. A “hardware module” (or just “hardware”) as used herein is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as an FPGA or an ASIC. A hardware module may also include programmable logic or circuitry that is temporarily configured by software to perform certain operations. A hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where a plurality of hardware modules exist contemporaneously, communications may be achieved through signal transmission (e.g., over appropriate circuits and buses) between or among two or more of the hardware modules. In embodiments in which a plurality of hardware modules is configured or instantiated at different times, communications between such hardware modules may be achieved, for example, through the storage and retrieval of information in memory structures to which the plurality of hardware modules have access.

As used herein, “network” or “networks” relates to any combination of electronic communication networks, including without limitation the Internet, a local area network (LAN), a wide area network, a wireless network, and a cellular network (e.g., 4G, 5G).

As used herein, “processes” or “methods” are presented in terms of processes (or methods) or symbolic representations of operations on data stored as bits or binary digital signals within a machine memory (e.g., a computer memory). These processes or symbolic representations are examples of techniques used by those of ordinary skill in the data processing arts to convey the substance of their work to others skilled in the art. As used herein, a “process” is a self-consistent sequence of operations or similar processing leading to a desired result. In this context, processes and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information.

As used herein, “processor-implemented module” relates to a hardware module implemented using one or more processors. The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein.

As used herein, “server” relates to a server computer or group of computers that acts to provide a service for a certain function or access to a network resource. A server may be a physical server, a hosted server in a virtual environment, or software code running on a platform.

As used herein, “service” or “application” relates to an online server (or set of servers), and can refer to a web site and/or web application.

As used herein, “software” relates to a set of instructions and associated documentations that tells a computer what to do or how to perform a task. Software includes all different software programs on a computer, such as applications and the operating system. A software application could be written in substantially any suitable programming language, which could easily be selected by one of ordinary skill in the art. The programming language chosen should be compatible with the computer by which the software application is to be executed and, in particular, with the operating system of that computer. Examples of suitable programming languages include without limitation Object Pascal, C, C++, CGI, Java, and Java Scripts. Further, the functions of some embodiments, when described as a series of steps for a method, could be implemented as a series of software instructions for being operated by a processor, such that the embodiments could be implemented as software, hardware, or a combination thereof.

As used herein, “sensor” relates to any device, component and/or system that can perform one or more of detecting, determining, assessing, monitoring, measuring, quantifying, and sensing something.

As used herein, “real-time” relates to a level of processing responsiveness that a user, module, or system senses as sufficiently immediate for a particular process or determination to be made, or that enables the processor to keep up with some external process.

As used herein, “user” relates to a consumer, machine entity, and/or requesting party, and may be human or machine.

As used herein, “widget” relates to electronic visual tiles that may be added to a home screen dashboard that are bigger than a regular application widget and have additional functionality. The widget may include shortcuts directly to popular features within a financial application.

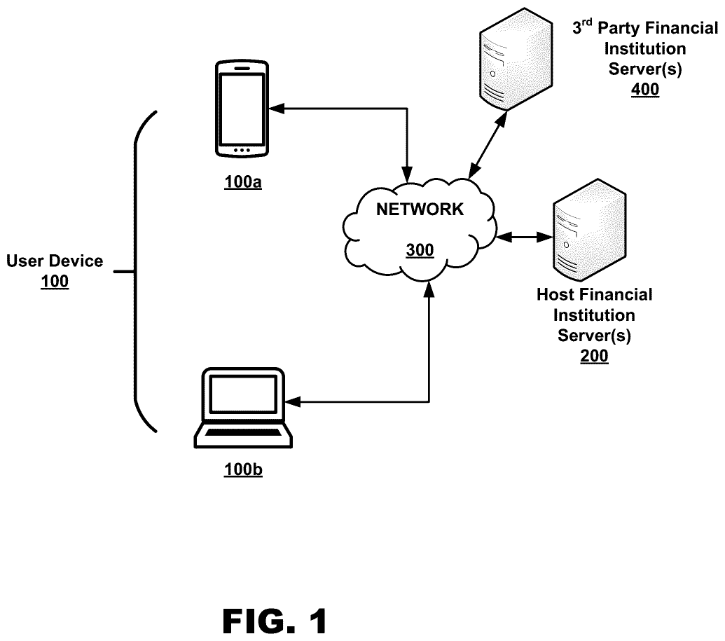

Turning to the figures, in which FIG. 1 illustrates a communication environment in which a user communicates with a financial institution. A client device 100 operating in the communication environment facilitates user access to and user management of one or more user financial accounts residing at one or more host financial institution servers 200 of a host financial institution. The communication environment includes the client device 100, the one or more host financial institution servers 200, one or more third-party financial institution servers 300 associated with one or more third-party financial institutions, and a communications network 300 through which communication is facilitated between the client device 100, the one or more host financial institution servers 200, and the one or more third-party financial institution servers 400.

In accordance with one or more embodiments, a client device 100 of the user can, via the communications network 300, access data/information associated with the one or more user financial accounts that reside at the one or more host financial institution servers 200. The one or more host financial institution servers 200 operate and maintain a user interface (e.g., a website associated with the financial institution, or a mobile software application associated with the financial institution) which provides information and functionality for the financial accounts maintained by the host financial institution.

In accordance with one or more embodiments, the client device 100 comprises a computing device, including but not limited to a desktop computer, a laptop computer, a smart phone, a handheld personal computer, a workstation, a game console, a cellular phone, a mobile device, a personal computing device, a wearable electronic device, a smartwatch, smart eyewear, a tablet computer, a convertible tablet computer, or any other electronic, microelectronic, or micro-electromechanical device for processing and communicating data. This disclosure contemplates the client device 100 comprising any form of electronic device that optimizes the performance and functionality of the one or more embodiments in a manner that falls within the spirit and scope of the principles of this disclosure.

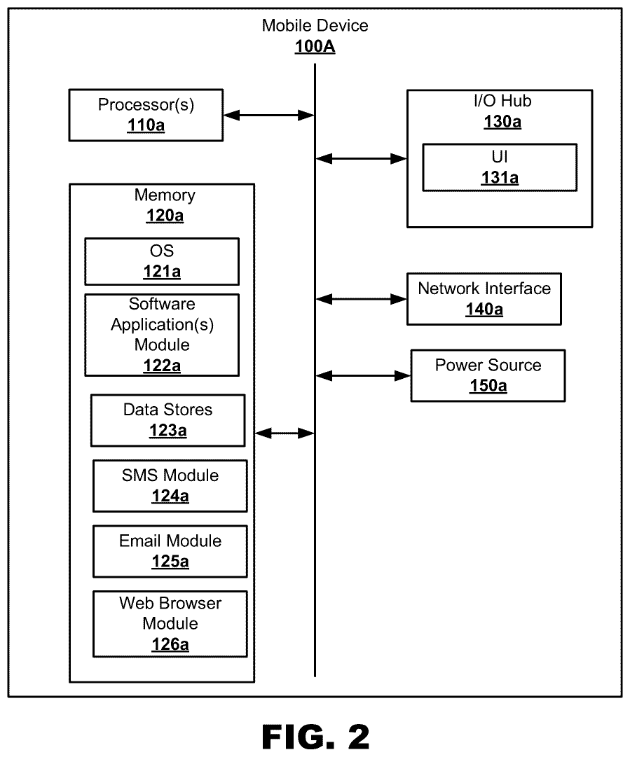

In the illustrated example embodiment of FIG. 2, the client device 100 comprises a mobile device 100a. Some of the possible operational elements of the mobile device 100a are illustrated in FIG. 2 and will now be described herein. It will be understood that it is not necessary for the mobile device 100a to have all the elements illustrated in FIG. 2. For example, the mobile device 100a may have any combination of the various elements illustrated in FIG. 2. Moreover, the mobile device 100a may have additional elements to those illustrated in FIG. 2.

The mobile device 100a includes one or more processors 110a, a non-transitory memory 120a operatively coupled to the one or more processors 110a, an I/O hub 130a, a network interface 140a, and a power source 150a.

The memory 120a comprises a set of instructions of computer-executable program code. The set of instructions are executable by the one or more processors 110a to cause the one or more processors 110a to execute an operating system 121A and one or more software applications of a software application module 122a that reside in the memory 120a. The one or more software applications residing in the memory 120a includes, but is not limited to, a financial institution application that is associated with the financial institution and which facilitates user access to the one or more user accounts in addition to user management of the one or more user accounts. The financial institution application comprises a mobile financial institution application that facilitates establishment of a secure connection between the mobile device 100a and the one or more financial institution servers 200.

The memory 120a also includes one or more data stores 123a that are operable to store one or more types of data. The mobile device 100a may include one or more interfaces that facilitate one or more systems or modules thereof to transform, manage, retrieve, modify, add, or delete, the data residing in the data stores 123a. The one or more data stores 123a may comprise volatile and/or non-volatile memory. Examples of suitable data stores 123a include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 123a may be a component of the one or more processors 110a, or alternatively, may be operatively connected to the one or more processors 110a for use thereby. As set forth, described, and/or illustrated herein, “operatively connected” may include direct or indirect connections, including connections without direct physical contact.

The memory 120a also includes an SMS module 124a operable to facilitate user transmission and receipt of text messages via the mobile device 100a though the network 300. In one example embodiment, a user may receive text messages from the financial institution that are associated with the user access and the user management of the one or more user accounts. An email module 125a is operable to facilitate user transmission and receipt of email messages via the mobile device 100a through the network 300. In one example embodiment, a user may receive email messages from the financial institution that are associated with the user access and the user management of the one or more user accounts. A user may utilize a web browser module 126A that is operable to facilitate user access to one or more websites associated with the financial institution through the network 300. A digital wallet module (not pictured) facilitates the generation of one or more digital wallets associated with the one or more financial accounts.

In accordance with one or more embodiments, the mobile device 100a includes an I/O hub 130a operatively connected to other systems and subsystems of the mobile device 100a. The I/O system 130a may include one or more of an input interface, an output interface, and a network controller to facilitate communications between the client device 100 and the server 200. The input interface and the output interface may be integrated as a single, unitary user interface 131a, or alternatively, be separate as independent interfaces that are operatively connected.

As used herein, the input interface is defined as any device, software, component, system, element, or arrangement or groups thereof that enable information and/or data to be entered as input commands by a user in a manner that directs the one or more processors 110a to execute instructions. The input interface may comprise a user interface (UI), a GUI, such as, for example, a display, human-machine interface (HMI), or the like. Embodiments, however, are not limited thereto, and thus, this disclosure contemplates the input interface comprising a keypad, touch screen, multi-touch screen, button, joystick, mouse, trackball, microphone and/or combinations thereof.

As used herein, the output interface is defined as any device, software, component, system, element or arrangement or groups thereof that enable information/data to be presented to a user. The output interface may comprise one or more of a visual display or an audio display, including, but not limited to, a microphone, earphone, and/or speaker. One or more components of the mobile device 100a may serve as both a component of the input interface and a component of the output interface.

The mobile device 100a includes a network interface 140a operable to facilitate connection to the network 300. The mobile device 100a also includes power source 150a that comprises a wired powered source, a wireless power source, a replaceable battery source, or a rechargeable battery source.

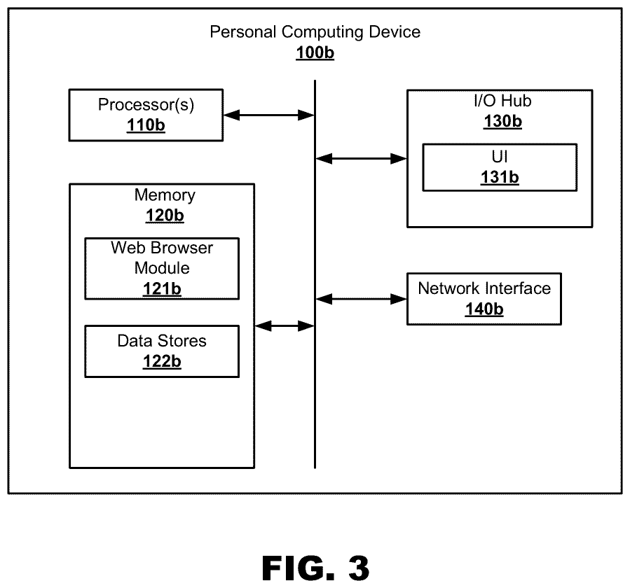

In the illustrated example embodiment of FIG. 3, the client device 100 comprises a personal computing device 100b. Some of the possible operational elements of the personal computing device 100b are illustrated in FIG. 3 and will now be described herein. It will be understood that it is not necessary for the personal computing device 100b to have all the elements illustrated in FIG. 3. For example, the personal computing device 100b may have any combination of the various elements illustrated in FIG. 3. Moreover, the personal computing device 100b may have additional elements to those illustrated in FIG. 3.

The personal computing device 100b includes one or more processors 110b, a non-transitory memory 120b operatively coupled to the one or more processors 110a, an I/O hub 130b, and a network interface 140b.

The memory 120b comprises a set of instructions of computer-executable program code. The set of instructions are executable by the one or more processors 110b to cause the one or more processors 110b to control the web browser module 121b in a manner that facilitates user access to a web browser having one or more websites associated with the financial institution through the network 300.

The memory 120b also includes one or more data stores 122b that are operable to store one or more types of data. The personal computing device 100b may include one or more interfaces that facilitate one or more systems or modules thereof to transform, manage, retrieve, modify, add, or delete, the data residing in the data stores 122b. The one or more data stores 122a may comprise volatile and/or non-volatile memory. Examples of suitable data stores 122b include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 122b may be a component of the one or more processors 110b, or alternatively, may be operatively connected to the one or more processors 110b for use thereby. As set forth, described, and/or illustrated herein, “operatively connected” may include direct or indirect connections, including connections without direct physical contact.

In accordance with one or more embodiments set forth, described, and/or illustrated herein, “processor” means any component or group of components that are operable to execute any of the processes described herein or any form of instructions to carry out such processes or cause such processes to be performed. The one or more processors 110a, 110b may be implemented with one or more general-purpose and/or one or more special-purpose processors. Examples of suitable processors include graphics processors, microprocessors, microcontrollers, DSP processors, and other circuitry that may execute software. Further examples of suitable processors include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. The one or more processors 110a, 110b may comprise at least one hardware circuit (e.g., an integrated circuit) operable to carry out instructions contained in program code. In embodiments in which there is a plurality of processors, such processors may work independently from each other, or one or more processors may work in combination with each other.

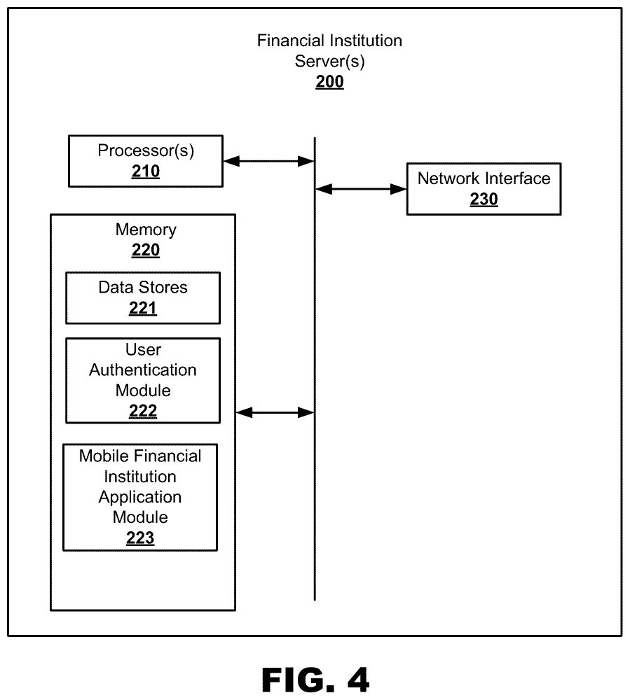

As illustrated in FIG. 4, the one or more host financial institution servers 200 includes one or more processors 210, a non-transitory memory 220 operatively coupled to the one or more processors 210, and a network interface 230. Some of the possible operational elements of each server in the one or more financial institution servers 200 are illustrated in FIG. 4 and will now be described herein. It will be understood that it is not necessary for each server in the one or more financial institution servers 200 to have all the elements illustrated in FIG. 4. For example, each server in the one or more financial institution servers 200 may have any combination of the various elements illustrated in FIG. 4. Moreover, each server in the one or more financial institution servers 200 may have additional elements to those illustrated in FIG. 4.

The memory 220 comprises a set of instructions of computer-executable program code. The set of instructions are executable by the one or more processors 210 in manner that facilitates control of a user authentication module 222 and a mobile financial institution application module 223 having one or more mobile financial institution applications that reside in the memory 220.

The memory 220 also includes one or more data stores 221 that are operable to store one or more types of data, including but not limited to, user account data and user authentication data. The one or more data stores 221 may comprise volatile and/or non-volatile memory. Examples of suitable data stores 221 include, but are not limited to RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The one or more data stores 221 may be a component of the one or more processors 210, or alternatively, may be operatively connected to the one or more processors 210 for use thereby. As set forth, described, and/or illustrated herein, “operatively connected” may include direct or indirect connections, including connections without direct physical contact.

The computer-executable program code may instruct the one or more processors 210 to cause the user authentication module 222 to authenticate a user in order to gain user access to the one or more user accounts. The user authentication module 222 may be caused to request user input user data or user identification that include, but are not limited to, user identity (e.g., username), a user passcode, a cookie, user biometric data, a private key, a token, and/or another suitable authentication data or information.

The computer-executable program code of the one or more mobile financial institution applications of the mobile financial institution application module 222 may instruct the one or more processors 210 to execute certain logic, data-processing, and data-storing functions of the one or more financial institution servers 200, in addition to certain communication functions of the one or more financial institution servers 200. The one or more mobile financial institution applications of the mobile financial institution application module 222 are operable to communicate with the client device 100 in a manner which facilitates user access to the one or more user accounts in addition to user management of the one or more user accounts based on successful user authentication.

The one or more host financial institution servers 200 are operable to access the data/information associated with the financial accounts of the user that are maintained at the third-party financial institution servers 400. In one example, the one or more host financial institution servers 200 may utilize the login credentials of the user to retrieve all data/information related to the financial accounts of the user that are maintained at the one or more third-party financial institution servers 400. The one or more host financial institution servers 200 may also issue commands to the one or more third-party financial institution servers 400 as if the one or more financial institution servers 200 were the user.

In accordance with one or more embodiments set forth, described, and/or illustrated herein, the network 300 may comprise a wireless network, a wired network, or any suitable combination thereof. For example, the network 300 is operable to support connectivity using any protocol or technology, including, but not limited to wireless cellular, wireless broadband, wireless local area network (WLAN), wireless personal area network (WPAN), wireless short distance communication, Global System for Mobile Communication (GSM), or any other suitable wired or wireless network operable to transmit and receive a data signal.

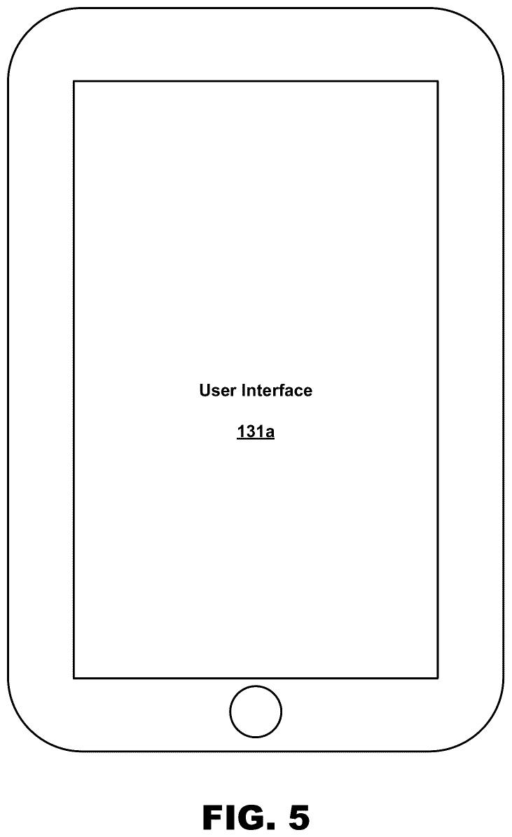

As illustrated in FIG. 5, the computer-executable program code may instruct the one or more processors 210 to cause the display, generation, or rendering of a user interface 131a, 131b for visual display on the client device 100. The computer-executable program code may instruct the one or more processors 210 to cause the user authentication module 222 to generate or otherwise render a plurality of user input fields and output fields on the user interface 131a, 131b which can be received and transmitted to any other component illustrated herein.

In accordance with one or more embodiments set forth and described herein, a user can have financial accounts at one or more different financial institutions. As used herein, a financial institution is a business entity (e.g., bank, credit union, credit card network, trust company, brokerage company, insurance company, etc.) that provides products and services related to financial transactions and monetary transactions to personal and commercial customers/clients. A user, i.e., a client/customer of such products and services, may generally have a financial account maintained at different financial institutions. The user can, via a client device 100 (e.g., cell phone 100a, laptop or personal computer 100b, etc.) access data/information related to a financial account maintained at the one or more host financial institution servers 200 in at least two ways: by using a web browser running on the client device 100 to access the host financial institution server 200, or by using the client device 100 and downloading and executing mobile application software (“mobile app”) or desktop application software (“desktop app”) associated with the host financial institution on the client device 100 to access the one or more host financial institution servers 200. The one or more financial institution servers 200 can render or generate one or more GUIs for visual display on the user interface 131a, 131b of the client device 100 that displays the data/information (e.g., account balance, transaction history, bill pay, etc.) associated with the one or more financial accounts.

The one or more GUIs can display data/information associated with one or more financial accounts maintained by the host financial institution, but also data/information associated with one or more financial accounts maintained by third-party financial institutions. The one or more financial institution servers 200, having access (e.g., stored in the memory 220) to the authentication credentials (for the host financial institution and the third-party financial institutions) of the user, can access the data/information of the financial accounts of the user that are maintained at different third-party financial institutions in order to retrieve the data/information associated with the financial accounts and display the same via the one or more GUIs. The data/information from the financial accounts can then be visually displayed simultaneously on the interface 131a, 131b.

In accordance with one or more embodiments set forth and described herein, the digital financial management platform enables a user, when the client device 100 is executing mobile application software or desktop application software associated with the host financial institution or an online software application associated with the host financial institution, to selectively view on the use interface 131a, 131b all financial accounts maintained by the host financial institution and third-party financial institutions. The digital financial management platform also enables a user to make an inter-account funds transfer between financial accounts of the user that are maintained at the host financial institution and third-party financial institutions.

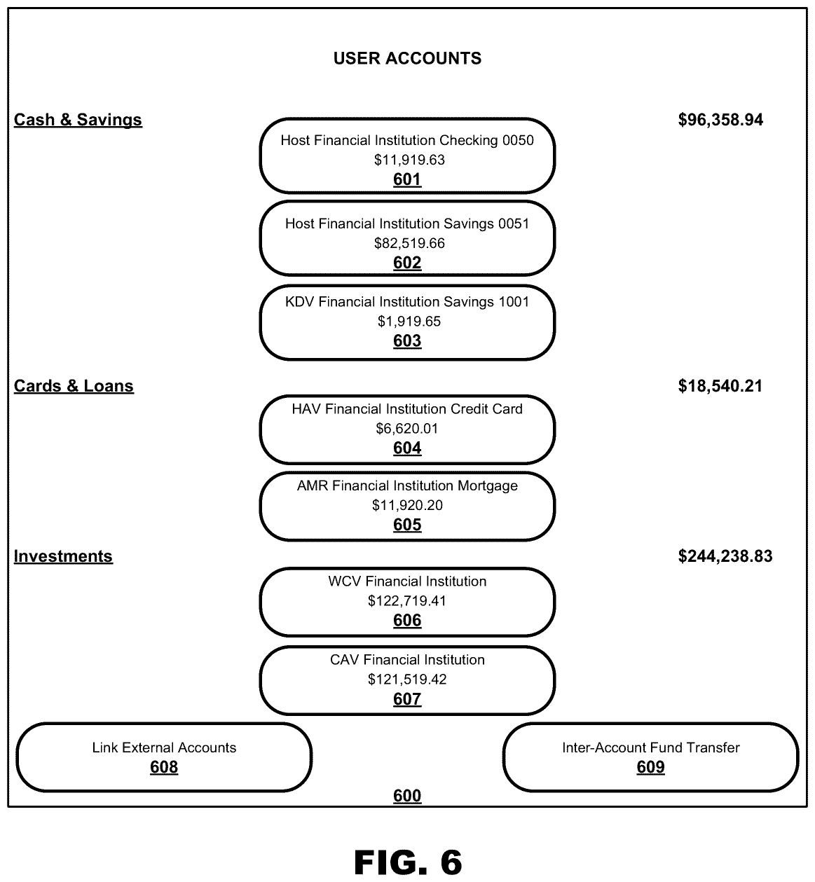

As illustrated in FIG. 6, a dashboard 600 for visual display on the user interface 131a, 131b of FIG. 5 is set forth in accordance with one or more embodiments set forth and described herein. The dashboard is presented on the interface 131a, 131b and provides the user (who is signed into the dashboard) a number of options to navigate the interface 131a, 131b so the user can obtain desired information or perform desired functions. In this example, the dashboard 600 is caused to be visually displayed by the one or more host financial institution servers 200. The host financial institution is the financial institution supporting the one or more host financial institution servers 200 which provides the user interface 131a, 131b (e.g., web site, mobile app, etc.) and to which the user is logged in to (using authentication credentials). The host financial institution also supports, distributes, and updates, via the mobile financial institution application module 223, the mobile application software or desktop application software associated with the host financial institution. The host financial institution mobile application software or desktop application software can be downloaded and executed on the client device 100, which provides the user all of the functionality (e.g., display balances for financial accounts maintained by the host financial institution, enable fund transfers, bill payments, tec.) described herein.

In the illustrated embodiment of FIG. 6, the computer-executable program code may instruct the one or more processors 210 to cause a visual display of a dashboard 600 on the user interface 131a, 131b of the client device 100. The dashboard 600 includes a plurality of widgets 601-607, including one or more widgets 601, 602 that visually display a financial account balance of the user that is associated with financial accounts maintained by the host financial institution, and one or more widgets 603-607 that visually display a financial account balance of the user that is associated with financial accounts maintained by third-party financial institutions.

The widgets 601-607 may be selectively aggregated on the dashboard 600 based on a classification or category type. For example, one or more widgets 601-603 associated with cash and savings financial accounts may be aggregated together, one or more widgets 604, 605 associated with credit cards and loans savings financial accounts may be aggregated together, and one or more widgets 606, 607 associated with investment financial accounts may be aggregated together. The widgets 601-607 may be user-engageable for manipulation by the user. For example, the user can manipulate (e.g., drag and drop) the widgets 601-607 in order to rearrange the order of the widgets 601-607. The user can also manipulate (e.g., touching, pointing, clicking, etc.) the widgets 601-607 in order to access additional data and more information (e.g., transaction history, etc.) and functionality with regard to the data/information.

During execution of the mobile application software or desktop application software associated with the host financial institution by the client device 100, a user may, via widget 608, manually add or link external accounts, i.e., financial accounts that are maintained by third-party financial institutions for display on the user interface 131a, 131b. The user may also manually unlink external accounts via the mobile application software or desktop application software. A user may also, via widget 608, initiate an inter-account funds transfer between the one or more financial accounts maintained by the host financial institution and the one or more external financial accounts maintained by the third-party financial institutions.

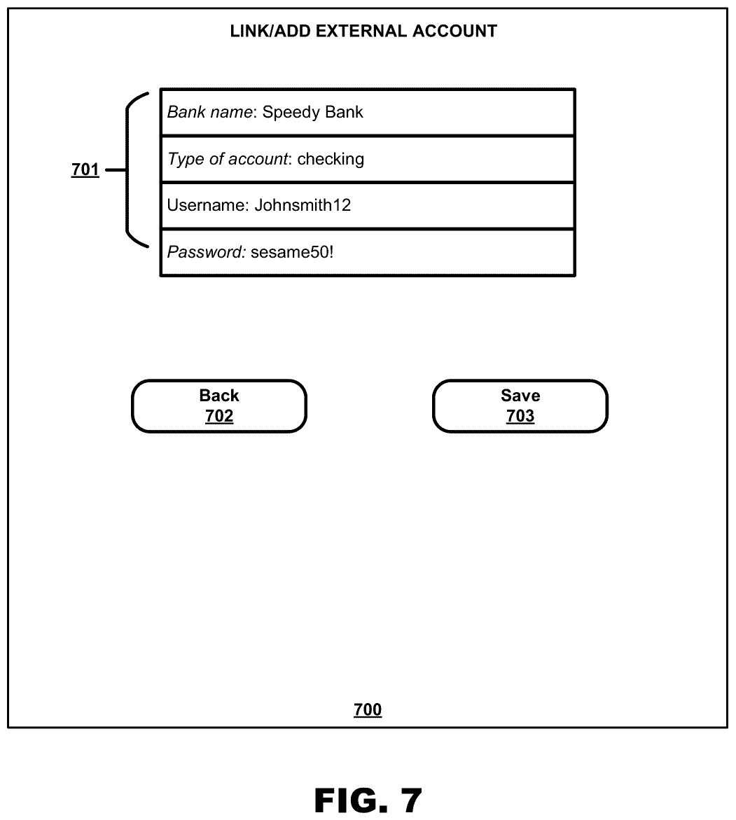

As illustrated in FIG. 7, in response to a user engaging widget 608, the computer-executable program code may instruct the one or more processors 210 to cause the display of a GUI 700 on the user interface 131a, 131b. The GUI 700 includes a plurality of widgets 701-703 to facilitate the linking or addition of an external account maintained by a third-party financial institution, in accordance with one or more embodiments set forth and described herein. The widget 701 includes one or more input fields that enable the user to populate with data/information associated with the external account. The data/information include, but is not limited to, the name of the third-party financial institution, the type of financial account, username, password, and any other data/information (e.g., user authentication credentials) that will enable the one or more host financial servers 200 to access the data/information associated with the external financial accounts. The one or more host financial institution servers 200 are operable to log into the third-party financial institution servers 400 using the user authentication credentials, and scrape data/information, for example, by capturing data/information provided by the one or more third-party financial institution servers 400. The scraped data/information can include, but is not limited to, financial account balances at the third-party financial institution (associated with the third-party financial institution servers 400), transaction history (e.g., all individual transactions including the name of the payee, the monetary amount, transaction date, etc.), and any other data/information that is made available by the third-party financial institution severs 400 when a user logs into their respective account. All of the data/information retrieved or acquired from the third-party financial institution servers 400 can be stored in the memory 200 and associated with the one or more financial accounts of the user that are maintained by the host financial institution servers 200. The host financial institution servers 200 may periodically (e.g., daily, weekly, biweekly, etc.) and automatically log into the third-party financial institution servers 400 to access and acquired updated data/information.

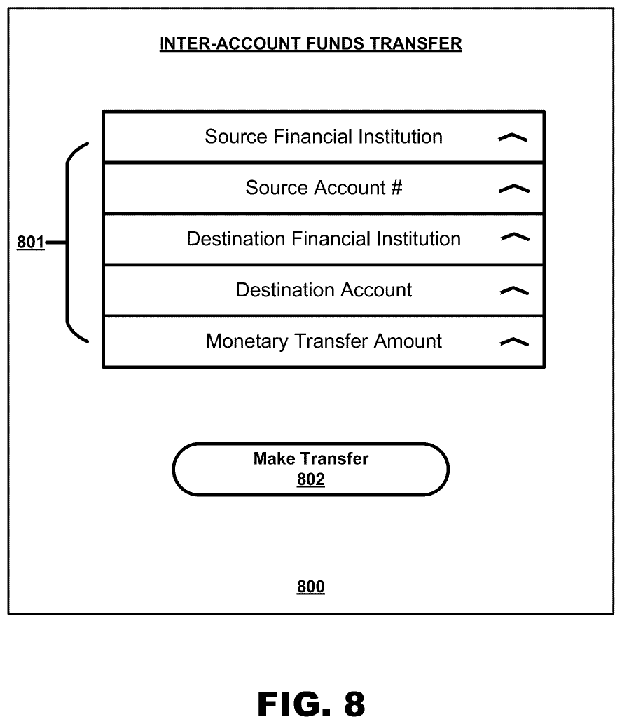

As illustrated in FIG. 8, in response to a user engaging widget 609, the computer-executable program code may instruct the one or more processors 210 to cause a display of a GUI 800 on the user interface 131a, 131b. The GUI 800 includes a plurality of widgets 801 having an arrowhead that allows the user to populate input fields with instructions necessary to execute an inter-account funds transfer. The instructions include, but is not limited to, the source financial institution, the source account number associated with the source financial institution, the destination financial institution, the destination account number associated with the destination financial institution, and the monetary amount to transfer. Any additional information needed to execute the inter-account funds transfer can be requested as well (e.g., routing numbers, SWIFT codes, etc.).

In response to the user engaging widget 802, the computer-executable program code may instruct the one or more processors 210 to cause the inter-account funds transfer between the one or more financial accounts maintained by the host financial institution and the one or more external financial accounts maintained by the third-party financial institutions. Accordingly, the one or more host financial institution servers 200 can execute, in response to a user request, an inter-account fund transfer between the host financial institution and an external financial account maintained by a third-party financial institution. Additionally, the one or more host financial institution servers 200 can execute, in response to a user request, an inter-account fund transfer between external financial accounts maintained by two third-party financial institutions.

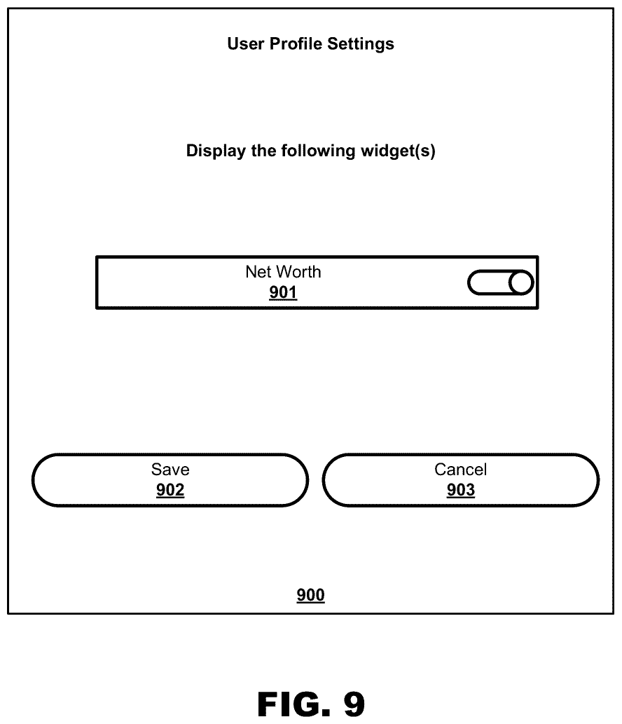

As illustrated in FIG. 9, the computer-executable program code may instruct the one or more processors 210 to cause a display of a GUI 900 on the user interface 131a, 131b. The GUI 900 comprises a profile settings dashboard that includes one or more widgets 901 having a user-engageable toggle switch to selectively enable or disable the preview of a current financial net worth of the user. In response to the user manipulating the toggle-switch to an enable-position (i.e., towards the right) and engaging a widget 902 to save the setting, the computer-executable program code may instruct the one or more processors 210 to execute a calculation of the current financial net worth based on the previewed account balances (on GUI 600 of FIG. 6) of the one or more financial accounts maintained by the host financial institution and the account balances of the financial accounts maintained by one or more third-party financial institutions. The computer-executable program code may instruct the one or more processors 210 to execute other calculations, including, a change in financial net worth of the user over a defined time period, a change in assets of the user over a defined time period, and a change in liabilities of the user over a defined time period.

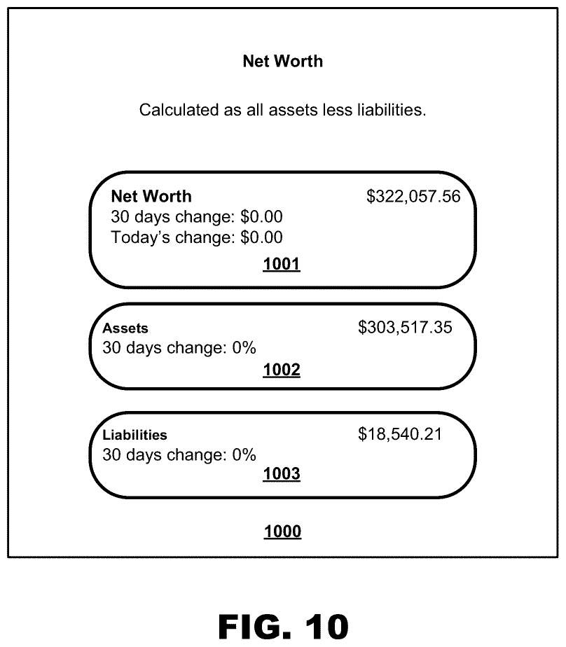

As illustrated in FIG. 10, the computer-executable program code may instruct the one or more processors 210 to cause a display of a GUI 1000 on the user interface 131a, 131b. The GUI 1000 comprises one or more widgets, including a widget 1001 which visually displays the calculated current financial net worth of the user, a widget 1002 which visually displays the current assets of the user, and a widget 1003 which visually displays the current liabilities of the user. This disclosure contemplates the widgets 1001-1003 may include other data, including, but not limited to the calculated change in financial net worth of the user over a defined time period, the calculated change in assets of the user over a defined time period, and the calculated change in liabilities of the user over a defined time period.

In accordance with one or more embodiments set forth, described, and/or illustrated herein, software executed by the one or more financial institution servers 200 provides functionality described or illustrated herein.

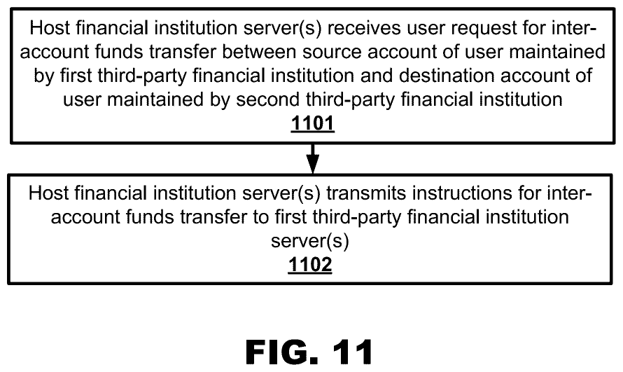

Illustrated examples shown in FIGS. 11 to 15 set forth computer-implemented methods 1100, 1200, 1300, 1400, and 1500. In one or more examples, the respective flowcharts of the computer-implemented methods 1100, 1200, 1300, 1400, and 1500 may be implemented by the one or more processors 210 of the one or more financial institution servers 200. In particular, the computer-implemented methods 1100, 1200, 1300, 1400, and 1500 may be implemented as one or more modules in a set of logic instructions stored in a non-transitory machine- or computer-readable storage medium such as random access memory (RAM), read only memory (ROM), programmable ROM (PROM), firmware, flash memory, etc., in configurable logic such as, for example, programmable logic arrays (PLAs), field programmable gate arrays (FPGAs), complex programmable logic devices (CPLDs), in fixed-functionality hardware logic using circuit technology such as, for example, application specific integrated circuit (ASIC), complementary metal oxide semiconductor (CMOS) or transistor-transistor logic (TTL) technology, or any combination thereof.

In accordance with one or more embodiments set forth, described, and/or illustrated herein, software executed by the one or more host financial institution servers 200 provides functionality described or illustrated herein. In particular, software executed by the one or more processors 210 is operable to perform one or more processing blocks of the computer-implemented methods 1100, 1200, 1300, 1400, and 1500 set forth, described, and/or illustrated herein, or provides functionality set forth, described, and/or illustrated.

There are different case scenarios to execute an inter-account funds transfer. In one example embodiment, the host financial institution is not the source nor the destination of the inter-account funds transfer. In which case, the inter-account funds transfer from financial accounts associated with third-party financial institutions is initiated by the one or more host financial institution servers 200. In another example embodiment, a financial account maintained by the host financial institution is the destination account and an account maintained by a third-party financial institution is the source account of the inter-account funds transfer. In a further example embodiment, a financial account maintained by the host financial institution is the source account and an account maintained by a third-party financial institution is the destination account of the inter-account funds transfer. Note that in all example embodiments, the inter-account funds transfer request will be automatically denied should the source account not contain a sufficient amount of monetary funds to cover the requested monetary amount to transferred.

As illustrated in FIG. 11, a computer-implemented method may facilitate, during execution of mobile application software or desktop application software associated with the host financial institution by a client device of a user having one or more financial accounts maintained by the host financial institution, an inter-account funds transfer between financial accounts of the user that are maintained by different third-party financial institutions, in accordance with one or more embodiments set forth and described herein. In the illustrated embodiment, the source financial account is maintained by a first third-party financial institution associated with one or more first third-party financial institution servers, and the destination financial account is maintained by a second third-party financial institution associated with one or more second third-party financial institution servers.

As illustrated in process block 1101, the one or more host financial institution servers are to receive, during execution of mobile application software or desktop application software associated with the host financial institution by the client device of the user, a request to implement the inter-account funds transfer.

In accordance illustrated process block 1101, the request can include data/information comprising the source financial account for the inter-account funds transfer, the destination financial account for the inter-account funds transfer, the monetary amount to be transferred, and the date the inter-account funds transfer should be implemented.

The computer-implemented method 1100 may then proceed to illustrated process block 1102, which includes the one or more host financial institution servers transmitting instructions to the first third-party financial institution servers for the inter-account funds transfer. The request can be made by causing the population of the data/information at the web site administered by the one or more first third-party financial institution servers as if a human user was making the request. In addition, the one or more host financial institution servers may cause the transmission of a secure file to the one or more first third-party financial institution servers, the secure file containing a set of instructions to be executed (e.g., steps to transfer the monetary funds) by the first third-party financial institution server to complete the inter-account funds transfer.

The monetary funds for inter-account funds transfer can be transferred in a number of ways, including, but not limited to, a ZELLE transfer, a wire transfer, an ACH transfer, etc. The one or more host financial institution servers would store and maintain all of the data/information (e.g., for all financial accounts it would store associated email addresses, passwords, authentication credentials, account numbers, routing numbers, etc.) necessary to execute the inter-account funds transfer.

Once the one or more host financial institution servers transmits a request for the inter-account funds transfer for a specified monetary amount from the source account (maintained by the first third-party financial institution) to the destination account (maintained by the second third-party financial institution), the one or more first third-party financial institution severs would typically execute the transfer at this point. Transfers may be instantaneous or may take some time (e.g., hours, a day, days, etc.). The account information on the dashboard can be automatically updated by the one or more host financial institution servers to reflect the inter-account funds transfer (e.g., funds are deducted from the source account balance and added to the destination account balance), although in an embodiment the monetary funds would only be shown to be added to the destination account balance once the transfer has been completed.

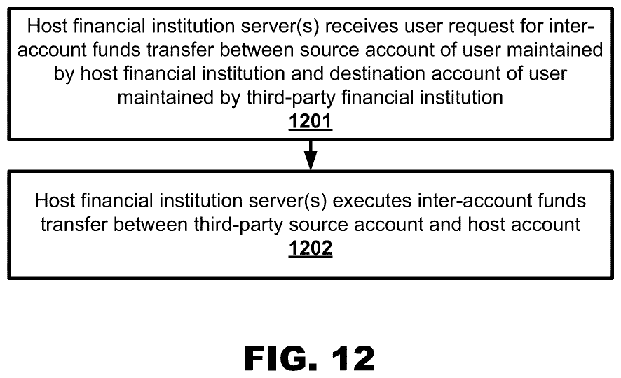

As illustrated in FIG. 12, a computer-implemented method may facilitate, during execution of mobile application software or desktop application software associated with the host financial institution by a client device of a user having one or more financial accounts maintained by the host financial institution, an inter-account funds transfer between a financial account of the user that is maintained by the host financial institution and a financial account of the user that is maintained by a third-party financial institution can be implemented, in accordance with one or more embodiments set forth and described herein. In the illustrated embodiment, the source financial account is maintained by the host financial institution, and the destination financial account is maintained by the third-party financial institution associated with one or more third-party financial institution servers.

As illustrated in process block 1201, the one or more host financial institution servers are to receive, during execution of mobile application software or desktop application software associated with the host financial institution by the client device of the user, a request to implement the inter-account funds transfer.

In accordance illustrated process block 1201, the request can include data/information comprising the source financial account for the inter-account funds transfer, the destination financial account for the inter-account funds transfer, the monetary amount to be transferred, and the date the inter-account funds transfer should be implemented.

The computer-implemented method 1200 may then proceed to illustrated process block 1202, which includes the one or more host financial institution servers executing the inter-account funds transfer to the first third-party financial institution servers for the inter-account funds transfer.

The monetary funds for the inter-account funds transfer can be transferred in a number of ways, including, but not limited to, a ZELLE transfer, a wire transfer, an ACH transfer, etc. The one or more host financial institution servers would store and maintain all of the data/information (e.g., for all financial accounts it would store associated email addresses, passwords, authentication credentials, account numbers, routing numbers, etc.) necessary to execute the inter-account funds transfer.

The account information on the dashboard can be automatically updated by the one or more host financial institution servers to reflect the inter-account funds transfer (e.g., funds are deducted from the source account balance and added to the destination account balance), although in an embodiment the monetary funds would only be shown to be added to the destination account balance once the transfer has been completed.

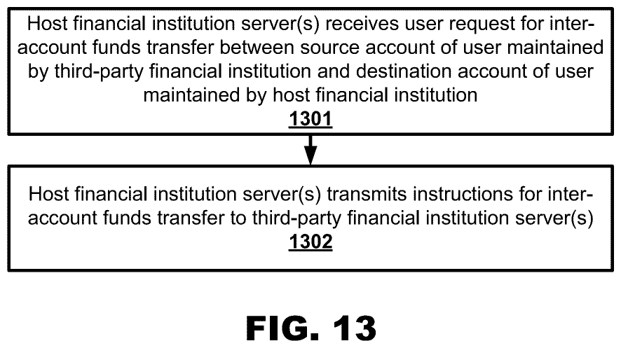

As illustrated in FIG. 13, a computer-implemented method may facilitate, during execution of mobile application software or desktop application software associated with the host financial institution by a client device of a user having one or more financial accounts maintained by the host financial institution, an inter-account funds transfer between financial accounts of the user that are maintained by the host financial institution and a third-party financial institution, in accordance with one or more embodiments set forth and described herein. In the illustrated embodiment, the source financial account is maintained by the third-party financial institution associated with one or more first third-party financial institution servers, and the destination financial account is maintained by the host financial institution associated with one or more host financial institution servers.

As illustrated in process block 1301, the one or more host financial institution servers are to receive, during execution of mobile application software or desktop application software associated with the host financial institution by the client device of the user, a request to implement the inter-account funds transfer.

In accordance illustrated process block 1301, the request can include data/information comprising the source financial account for the inter-account funds transfer, the destination financial account for the inter-account funds transfer, the monetary amount to be transferred, and the date the inter-account funds transfer should be implemented.

The computer-implemented method 1300 may then proceed to illustrated process block 1302, which includes the one or more host financial institution servers transmitting instructions to the one or more first third-party financial institution servers for executing the inter-account funds transfer. The transmission can be executed by causing the population of the data/information for the inter-account funds transfer at a web site administered by the one or more third-party financial institution servers as if a human user was making the request. In addition, the one or more host financial institution servers may cause the transmission of a secure file to the one or more third-party financial institution servers, the secure file containing a set of instructions to be executed (e.g., steps to transfer the monetary funds) by the third-party financial institution server to complete the inter-account funds transfer.

The monetary funds for inter-account funds transfer can be transferred in a number of ways, including, but not limited to, a ZELLE transfer, a wire transfer, an ACH transfer, etc. The one or more host financial institution servers would store and maintain all of the data/information (e.g., for all financial accounts it would store associated email addresses, passwords, authentication credentials, account numbers, routing numbers, etc.) necessary to execute the inter-account funds transfer.

Once the one or more host financial institution servers transmits a request for the inter-account funds transfer for a specified monetary amount from the source account (maintained by the third-party financial institution) to the destination account (maintained by the host financial institution), the one or more third-party financial institution severs would typically execute the transfer at this point. Transfers may be instantaneous or may take some time (e.g., hours, a day, days, etc.). The account information on the dashboard can be automatically updated by the one or more host financial institution servers to reflect the inter-account funds transfer (e.g., funds are deducted from the source account balance and added to the destination account balance), although in an embodiment the monetary funds would only be shown to be added to the destination account balance once the transfer has been completed.

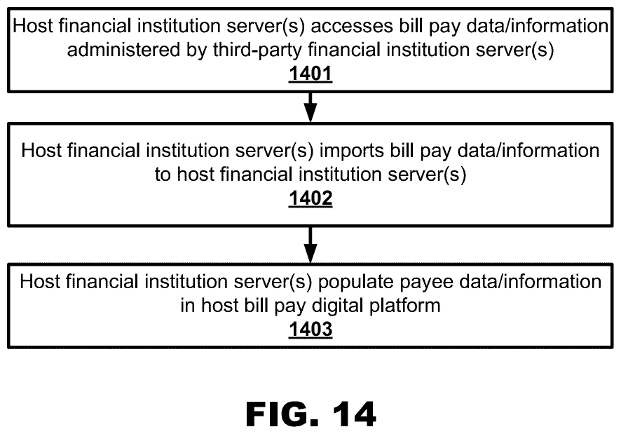

As illustrated in FIG. 14, a computer-implemented method may facilitate, during execution of mobile application software or desktop application software associated with the host financial institution by a client device of a user having one or more financial accounts maintained by the host financial institution, the import of payee data/information in a bill pay digital platform (“third-party bill pay digital platform”) administrated by one or more third-party financial institution servers associated with the third-party financial institution, to a bill pay digital platform (“host bill pay digital platform”), administrated by one or more host financial institution servers associated with a host financial institution. Accordingly, a user may augment payee data/information associated with the host bill pay digital platform with payee data/information associated with the third-party bill pay digital platform. This enables the user to make a payment, using mobile application software or desktop application software associated with the host financial institution, to payees in the third-party bill pay digital platform and the host bill pay digital platform.

As illustrated in process block 1401, the one or more host financial institution servers are to access, during execution of mobile application software or desktop application software associated with the host financial institution by a client device of a user, bill pay data/information associated with a financial account of the user maintained by a third-party financial institution, the data/information including payee data/information associated with a bill pay digital platform administered by one or more third-party financial institution servers associated with the third-party financial institution.

In accordance with process block 1401, accessing the data/information comprises the one or more host financial institution servers authenticating the user with the one or more third-party financial institution servers based on the authentication credentials of the user.

In accordance with process block 1401, accessing the data/information comprises using a robot or file exchange protocol to access the data/information.

The computer-implemented method 1400 may then proceed to illustrated process block 1402, which includes the one or more host financial institution servers importing the payee data/information from the one or more third-party financial institution servers to the one or more host financial institution servers.

The computer-implemented method 1400 may then proceed to illustrated process block 1403, which includes the one or more host financial institution servers populating the payee data/information in a bill pay digital platform administered by the one or more host financial institution servers.

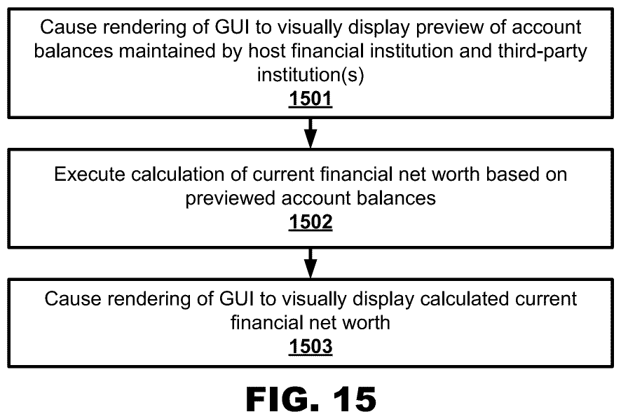

As illustrated in FIG. 15, a computer-implemented method may facilitate, during execution of mobile application software or desktop application software associated with the host financial institution by a client device of a user having one or more financial accounts maintained by the host financial institution, a calculation of a current net worth of the user based on assets and liabilities associated with balances previewed on a GUI of a user interface of the client device.

As illustrated in process block 1501, the one or more host financial institution servers are to cause visual display of a GUI on a user interface of a client device, the GUI comprising one or more widgets that enable the user to preview balances of financial accounts associated with a host financial institution and third-party financial institutions.

The computer-implemented method 1500 may then proceed to illustrated process block 1502, which includes the one or more host financial institution servers executing a calculation of a current net worth of the user based on assets and liabilities associated with the previewed balances.

The computer-implemented method 1500 may then proceed to illustrated process block 1503, which includes the one or more host financial institution servers causing a rendering of a GUI to visually display the calculated net worth on the user interface of the client device.

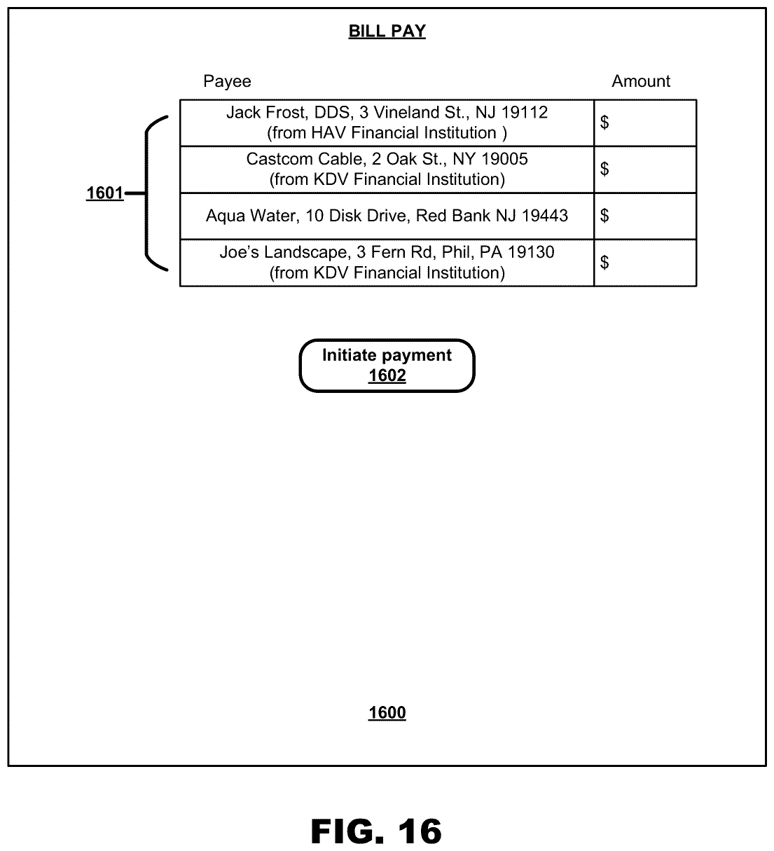

As illustrated in FIG. 16, the computer-executable program code may instruct the one or more processors 210 to cause a display of a GUI 1600 on the user interface 131a, 131b. The GUI 1600 comprises one or more widgets, including a widget 1601 which visually displays the payee data/information associated with the host bill pay management platform and the payee data/information imported from the third-party bill pay digital platform in accordance with the computer-implemented method of FIG. 14. The widget 1601 includes an input field to enable the user to specify a monetary amount to pay to payee. This disclosure contemplates the widget 1601 including an input field to enable the user to specific a date of execution of the payment. A user-engageable widget 1602 is provided to initiate payment, which is stored in the memory 220. Accordingly, the digital management platform enables a user to import payee data/information from the third-party bill pay digital platform for addition to the host digital platform. In that way, a digital management platform enables a single bill pay platform to management bill payments management associated with a host financial institution and third-party financial institutions.

Devices that are described as in “communication” with each other or “coupled” to each other need not be in continuous communication with each other or in direct physical contact, unless expressly specified otherwise. On the contrary, such devices need only transmit to each other as necessary or desirable and may actually refrain from exchanging data most of the time. For example, a machine in communication with or coupled with another machine via the Internet may not transmit data to the other machine for long period of time (e.g., weeks at a time). In addition, devices that are in communication with or coupled with each other may communicate directly or indirectly through one or more intermediaries.

The terms “coupled,” “attached,” or “connected” may be used herein to refer to any type of relationship, direct or indirect, between the components in question, and may apply to electrical, mechanical, fluid, optical, electromagnetic, electromechanical, or other connections. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action may occur, either in a direct or indirect manner.

All records and data described herein can be stored on any type of (non-transitory) computer readable storage medium, including hard disk, solid-state drive, flash memory, etc. The data can be stored in a database using any type of indexing and querying language, such as SQL, etc.

Those skilled in the art will appreciate from the foregoing description that the broad techniques of the exemplary embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

1. A server computing system, comprising:
a user authentication module;
a mobile financial institution application module having mobile application software or desktop application software for a host financial institution;
one or more processors; and
a non-transitory memory coupled to the one or more processors, the non-transitory memory including a set of instructions of computer-executable program code, which when executed by the one or more processors, cause the one or more processors to:
receive, via the user authentication module, personal user data associated with one or more external financial accounts of a user that are maintained by one or more third-party financial institutions,
store, via the user authentication module, the personal user data for the one or more external financial accounts,
acquire, via the user authentication module using the stored personal user data, external financial data of the user from one or more third-party financial institution servers, and
cause, during execution of the mobile application software or the desktop application software by a client device, the mobile financial institution application module to render a graphical user interface (GUI) for visual display on a user interface of the client device, the GUI aggregating and previewing account balances of one or more host financial accounts maintained by the host financial institution and account balances of the one or more external financial accounts.

2. (canceled)

3. The server computing system of claim 22, wherein:
the one or more host financial accounts comprise a source account for the inter-account funds transfer, and
the one or more external financial accounts comprise a destination account for the inter-account funds transfer.

4. The server computing system of claim 3, wherein the set of instructions, which when executed by the one or more processors, causes the one or more processors to:
verify, temporally before executing the inter-account funds transfer, that the source account has a sufficient amount of funds to cover a monetary amount associated with the inter-account funds transfer, and
execute the inter-account funds transfer when it is determined that the source account has a sufficient amount of funds to cover the monetary amount.

5. The server computing system of claim 22, wherein:
the one or more external financial accounts comprise a source account for the inter-account funds transfer, and
the one or more host financial accounts comprise a destination account for the inter-account funds transfer.

6. The server computing system of claim 5, wherein the set of instructions, which when executed by the one or more processors, causes the one or more processors to:
access, via the user authentication module using the stored personal user data temporally before executing the inter-account funds transfer, external financial data of the one or more external financial accounts stored at the one or more third-party financial institution servers,
verify, in response to accessing the external financial data, that the source account has a sufficient amount of funds to cover a monetary amount associated with the inter-account funds transfer, and
transmit the user request to one or more third-party financial institution servers associated with the one or more third-party financial institutions.

7. The server computing system of claim 22, wherein the set of instructions, which when executed by the one or more processors, causes the one or more processors to:
execute a calculation of a current financial net worth of the user based on the previewed account balances, and
cause a rendering of a second GUI for visual display on the user interface of the client device, the second GUI enabling the user to preview the calculated current financial net worth.

8. A computer-implemented method for enhanced data throughput via a server computing system, the computer-implemented method comprising:
providing, by one or more host financial institution servers of the server computing system, a user authentication module and a mobile financial institution application module having mobile application software or desktop application software for a host financial institution;
receiving, via the user authentication module, personal user data associated with one or more external financial accounts maintained by one or more third-party financial institutions;
storing, by the via the user authentication module, the personal user data for the one or more external financial accounts;
acquiring, via the user authentication module using the stored personal user data, external financial data of the user from one or more third-party financial institution servers; and
causing, during execution of the mobile application software or the desktop application software by a client device, the mobile financial institution application module to render a graphical user interface (GUI) for visual display on a user interface of the client device, the GUI aggregating and previewing account balances of one or more host financial accounts maintained by the host financial institution and account balances of the one or more external financial accounts.

9. (canceled)

10. The computer-implemented method of claim 23, wherein:
the one or more host financial accounts comprise a source account for the inter-account funds transfer, and
the one or more external financial accounts comprise a destination account for the inter-account funds transfer.

11. The computer-implemented method of claim 10, further comprising verifying, by the server computing system temporally before executing the inter-account funds transfer, that the source account has at least an amount of funds.

12. The computer-implemented method of claim 23, wherein:
the one or more external financial accounts comprise a source account for the inter-account funds transfer, and
the one or more host financial accounts comprise a destination account for the inter-account funds transfer.

13. The computer-implemented method of claim 12, further comprising;
accessing, by the server computing system using the stored personal user data temporally before executing the inter-account funds transfer, external financial data of the one or more external financial accounts stored at the one or more third-party financial institution servers, and
verifying, by the server computing system in response to accessing the one or more external financial accounts, that the source account has at least an amount of funds.

14. The computer-implemented method of claim 23, further comprising:
executing, by the one or more host financial institution servers, a calculation of a financial net worth of the user based on the previewed account balances, and
causing, by the one or more host financial institution servers, a rendering of a second GUI for visual display on the user interface of the client device, the second GUI enabling the user to preview the calculated current financial net worth.

15. A computer program product comprising at least one non-transitory computer readable medium having with a set of instructions of computer-executable program code, which when executed by one or more processors of a server computing system having mobile application software or desktop application software for a host financial institution, causes the server computing system:
receive, via a user authentication module of the server computing-system, personal user data associated with one or more external financial accounts of a user that are maintained by one or more third-party financial institutions;
store the personal user data for the one or more external financial accounts;
acquire, via the user authentication module using the stored personal user data, external financial data of the user from one or more third-party financial institution servers;
cause, during execution of the mobile application software or the desktop application software by a client device, the mobile financial institution application module of the server computing system to render a graphical user interface (GUI) for visual display on a user interface of the client device, the GUI aggregating and previewing account balances of one or more host financial accounts maintained by the host financial institution and account balances of the one or more external financial accounts.

16. The computer program product of claim 4-521, wherein:
the one or more host financial accounts comprise a source account for the inter-account funds transfer, and
the one or more external financial accounts comprise a destination account for the inter-account funds transfer.

17. The computer program product of claim 16, wherein the set of instructions, which when executed by the one or more processors, causes the server computing system to verify, temporally before executing the inter-account funds transfer, that the source account has at least an amount of funds.

18. The computer program product of claim 21, wherein:
the one or more external financial accounts comprise a source account for the inter-account funds transfer, and
the one or more host financial accounts comprise a destination account for the inter-account funds transfer.

19. The computer program product of claim 18, wherein the set of instructions, which when executed by the one or more processors, causes the server computing system to:
access, using the stored personal user data temporally before executing the inter-account funds transfer, external financial data of the one or more external financial accounts stored at the one or more third-party financial institution servers, and
verify, temporally before executing the inter-account funds transfer, that the source account has at least an amount of funds.

20. The computer program product of claim 21, wherein the set of instructions, which when executed by the one or more processors, causes the server computing system to:
execute a calculation of a financial net worth of the user based on the previewed account balances of the one or more host financial accounts maintained by the host financial institution and the account balances of the external financial accounts maintained by one or more third-party financial institutions, and
cause a rendering of a second GUI for visual display on the user interface of the client device, the second GUI enabling the user to preview the calculated current financial net worth.

21. The computer program product of claim 15, wherein the set of instructions, which when executed by the one or more processors, causes the server computing system to:
execute an inter-account funds transfer between one of the one or more host financial accounts visually displayed on the GUI and one of the one or more external financial accounts visually displayed on the GUI; and
automatically update, in response to completion of the inter-account funds transfer, the previewed account balances visually displayed on the user interface of the client device.

22. The server computing system of claim 1, wherein the set of instructions, which when executed by the one or more processors, causes the one or more processors to:
execute an inter-account funds transfer between one of the one or more host financial accounts visually displayed on the GUI and one of the one or more external financial accounts visually displayed on the GUI; and
automatically update, in response to completion of the inter-account funds transfer, the previewed account balances visually displayed on the user interface of the client device.

23. The computer-implemented method of claim 8, further comprising:
executing, by the server computing system, an inter-account funds transfer between one of the one or more host financial accounts visually displayed on the GUI and one of the one or more external financial accounts visually displayed on the GUI; and
automatically updating, the server computing system in response to completion of the inter-account funds transfer, the previewed account balances visually displayed on the user interface of the client device.
